(19) United States
(12) Patent Application Publication
(10) Pub. No.: US 2025/0173904 A1
(43) Pub. Date: May 29, 2025

(54) IMAGE PROCESSING METHOD, NETWORK MODEL TRAINING METHOD AND APPLICATION METHODS, IMAGE PROCESSING APPARATUS, NETWORK MODEL TRAINING APPARATUS AND STORAGE MEDIUM

(71) Applicant: CANON KABUSHIKI KAISHA, Tokyo (JP)

(72) Inventors: Dongyue Zhao, Beijing (CN); Wei Tao, Beijing (CN); Tsewei Chen, Tokyo (JP); Siran Peng, Beijing (CN); Lingxiao Yin, Beijing (CN)

(21) Appl. No.: 18/957,541

(22) Filed: Nov. 22, 2024

(30) Foreign Application Priority Data
Nov. 28, 2023 (CN) 202311610645.2

(51) Int. Cl. G06T 9/00; G06T 3/40; G06T 5/50; G06T 7/194; G06T 7/50; G06V 10/44; G06V 10/80

(52) U.S. Cl. CPC G06T 9/00; G06T 3/40; G06T 5/50; G06T 7/194; G06T 7/50; G06V 10/44; G06V 10/806; G06T 2207/20084; G06T 2207/20221

(57) ABSTRACT

The present disclosure provides methods and apparatuses of image processing, network model training, and application, and storage medium. The image processing method comprises: an encoding step of generating, based on an input image and an encoder, a plurality of encoded features of different resolutions; a decoding step of decoding based on the plurality of encoded features and a decoder of a plurality of cascaded decoding modules for a decoded feature of a same resolution as that of the input image; and a prediction step of predicting, based on the decoded feature and a head module, an output image having a same resolution as that of the input image.

### CROSS REFERENCE TO RELATED APPLICATIONS

The present application claims the benefit of Chinese Patent Application No. 202311610645.2, filed Nov. 28, 2023, which is hereby incorporated by reference herein in its entirety

### TECHNICAL FIELD

The present disclosure relates to an image processing method, a neural network model training method, an image processing apparatus, a neural network model training apparatus, application methods thereof, and a storage medium.

### BACKGROUND

Image matting is a fundamental task in computer vision. It aims to precisely segment a target image region by predicting alpha for each pixel. It is a typical ill-posed problem to estimate a foreground, a background, and the alpha from a single image, but has wide applications in the fields of image and video editing, virtual reality, augmented reality, entertainment, etc. Specifically, portrait image matting refers to a specific image matting task where the input image is a portrait without any external guidance.

Common image matting methods require a trimap as additional input based on which a predication or estimation of the alpha for each pixel in an uncertain region is performed. In recent years, due to the success of convolutional neural networks, researchers started the research of matting methods that do not need any external guidance. These matting models capture semantics and details by end-to-end trainings on large-scale datasets. However, due to a lack of semantic guidance, these methods are challenged in generalization when tested on complicated real images.

In 2021, in “Privacy-Preserving Portrait Matting” by Jizhizi Li, Sihan Ma, Jing Zhang, Dacheng Tao, there is proposed a portrait matting network P3M-Net based on a U-Net structure, which does not need additional guidance. It uses a unified end-to-end multitask framework for both semantic perception and detail matting, and specifically emphasizes an interaction between an encoder and the semantic perception and the detail matting, to facilitate the matting process. The network includes an encoder, a segmentation decoder, and a matting decoder, such as to explicitly model the semantic segmentation and detail matting, and optimize both of them. Meanwhile, the network further comprises a TFI module, a dBFI module, and a sBFI module to enhance the interaction effects between encoding and decoding, thereby enabling an extraction of better features.

The methods of the prior art generate the final matting result by fusing a global segmentation result and a local matting result, where the final matting result would be affected directly if the global segmentation result is relatively poor. Whilst segmentation decoders in the methods of the prior art acquire the final decoded features utilizing the high-dimensional semantic features of encoders only, and do not make full use of the features of the encoder, so the global segmentation result would be unsatisfying.

### SUMMARY

The present disclosure provides a neural network training method, by which a high-accuracy neural network model satisfying computation overhead restrictions can be searched out under a condition of limited search overhead.

According to an aspect of the present disclosure, there is provided an image processing method characterized in that the method comprises: an encoding step of generating, based on an input image and an encoder, a plurality of encoded features of different resolutions; a decoding step of decoding based on the plurality of encoded features and a decoder of a plurality of cascaded decoding modules for decoded features of a same resolution as that of the input image; and a prediction step of predicting, based on the decoded features and a head module, an output image of a same resolution with the input image.

According to another aspect of the present disclosure, there is provided a training method for a neural network model, comprising: a construction step of constructing a neural network model used in the method according to one aspect of the present disclosure; a prediction step of calculating, based on the constructed neural network model and data obtained from a training dataset, a predicted output result; and an update step of calculating a loss based on a loss function and the predicted output result, so as to update parameters of a current neural network.

According to another aspect of the present disclosure, there is provided an image processing apparatus. The apparatus comprises: an encoding unit configured to generate, based on an input image and an encoder, a plurality of encoded features of different resolutions; a decoding unit configured to decode based on the plurality of encoded features and a decoder of cascaded decoding modules for decoded features of a same resolution as the input image; and a prediction unit configured to predict, based on the decoded features and a head module, an output image of a same resolution as that of the input image.

According to another aspect of the present disclosure, there is provided a training apparatus for a neural network model, comprising: a construction unit configured to construct a neural network model used in the method according to one aspect of the present disclosure; a prediction unit configured to calculate, based on the constructed neural network model and data obtained from a training dataset, a predicted output result; and an update unit configured to calculate a loss based on a loss function and the predicted output result, so as to update parameters of a current neural network.

Further features of the present disclosure will become apparent from the following description of exemplary embodiments with reference to the attached drawings.

### BRIEF DESCRIPTION OF THE DRAWINGS

The drawings, which are incorporated in and constitute part of the specification, illustrate exemplary embodiments of the present disclosure and serve to explain, together with the descriptions on the exemplary embodiments, the principles of the present disclosure.

FIG. 1 is a block diagram illustrating a hardware configuration according to an exemplary embodiment of the present disclosure.

FIG. 2 illustrates an integrated decoding network according to an exemplary embodiment of the present disclosure.

FIG. 3 illustrates integrated decoding modules for various inputs according to an exemplary embodiment of the present disclosure.

FIG. 4 illustrates skip-connection sub-modules with various fusion manners according to an exemplary embodiment of the present disclosure.

FIG. 5 illustrates segmentation sub-modules adopting various guidance manners according to an exemplary embodiment of the present disclosure.

FIG. 6 illustrates matting sub-modules adopting various guidance manners according to an exemplary embodiment of the present disclosure.

FIG. 7 is a flow chart illustrating convolutional neural network mode training utilizing the integrated decoder 1 according to an exemplary embodiment of the present disclosure.

FIG. 8 is a flow chart illustrating convolutional neural network mode training utilizing the integrated decoder 2 according to an exemplary embodiment of the present disclosure.

FIG. 9 is a flow chart illustrating convolutional neural network mode training utilizing the integrated decoder 3 according to an exemplary embodiment of the present disclosure.

FIG. 10 is a flow chart illustrating convolutional neural network mode training utilizing the integrated decoder 4 according to an exemplary embodiment of the present disclosure.

FIG. 11 is a flow chart illustrating convolutional neural network mode training utilizing the integrated decoder 5 according to an exemplary embodiment of the present disclosure.

FIG. 12 is a schematic diagram illustrating a training system according to an exemplary embodiment of the present disclosure.

### DETAILED DESCRIPTION

Exemplary embodiments of the present disclosure will be described in details with reference to the drawings. For the purpose of being clear and concise, the specification does not describe all features of the embodiments. However, it is appreciated that it is necessary to make numerous configurations specific to respective embodiments in implementation of the embodiments, so as to realize the specific objective of the developing personnel. For example, restrictions associated with device and business may be satisfied; and the restrictions may vary according to different embodiments. In addition, it is appreciated that although the development work may be very complicated and time costly, such development work is merely routine task for a person skilled in the art benefited from the contents of the present disclosure.

Here, it should be noted that in order to prevent causing ambiguity of the present disclosure with unnecessary details, the accompanying drawings only show the processing steps and/or system structures of close concern at least according to the solution of the present disclosure; other details less associated with the present disclosure are omitted.

In the context of the present disclosure, “dataset” may refer to data comprising any image, such as a color image, a grayscale image, and the like. The type and format of the image are not limited specifically.

### <Hardware Configuration>

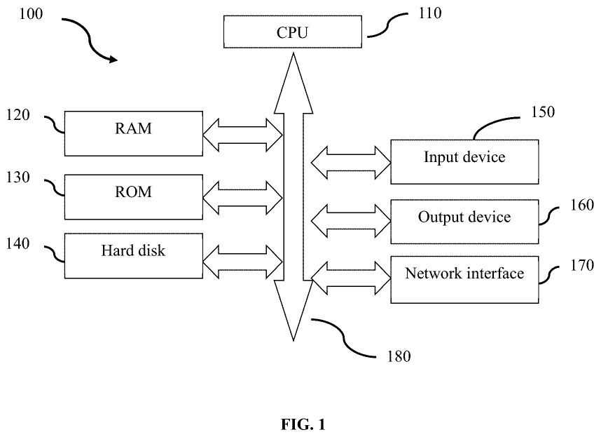

First, hardware configuration capable of implementing the techniques described subsequently is described with reference to FIG. 1.

The hardware configuration 100 comprises a central processing unit (CPU) 110, a random access memory (RAM) 120, a read-only memory (ROM) 130, a hard disk 140, an input device 150 an output device 160, a network interface 170, and a system bus 180, for example. In an implementation, the hardware configuration 100 is implementable by a computer, such as a tablet computer, a laptop computer, a desktop computer, or other suitable electronic devices.

In an implementation, an apparatus for training a neural network model according to the present disclosure is constructed by hardware or firmware and serves as a module or component of the hardware configuration 100. In another implementation, the method for training a neural network model according to the present disclosure is constructed by software stored in the ROM 130 or the hard disk 140 and executed by the CPU 110.

The CPU 110 is any suitable programmable control device (e.g., processor) and may perform various functions described subsequently by executing various applications stored in the ROM 130 or the hard disk 140 (e.g., memory). The RAM 120 is used to temporarily store program or data loaded from the ROM 130 or the hard disk 140 and also serves as a space for the CPU 110 to execute various processes and other available functions. The hard disk 140 stores various information such as an operational system (OS), various applications, a control program, a sample image, a neural network model from training, predefined data (e.g., threshold THs), and the like.

In an implementation, the input device 150 is configured to enable a user to interact with the hardware configuration 100. In an example, the user may input a sample image and a label of the sample image (e.g., region information of an object, category information of the object, etc.) via the input device 150. In a further instance, the user may trigger a corresponding process of the present disclosure via the input device 150. In addition, the input device 150 may take various forms, such as a button, a keyboard, or a touch screen.

In an implementation, the output device 160 is used to store a final neural network model from training into e.g., the hard disk 140 or is used to output the final generated neural network model to subsequent image processing such as object detection, object classification, image segmentation, and the like.

The network interface 170 provides an interface for connecting the hardware configuration 100 to a network. For example, the hardware configuration 100 may perform data communication with other electronic devices connected a the network via the network interface 170. Optionally, a wireless interface may be provided for the hardware configuration 100 for wireless data communication. The system bus 180 may provide a data transmission path for mutual data transmission among the CPU 110, the RAM 120, the ROM 130, the hard disk 140, the input device 150, the output device 160, and the network interface 170. Though referred to as a bus, the system bus 180 is not limited to any specific data transmission technique.

The afore-described hardware configuration 100 is merely illustrative; it is not intended to limit the present disclosure or the application or use thereof. In addition, for the sake of conciseness, FIG. 1 illustrates only one hardware configuration. Nonetheless, multiple hardware configurations may be utilized as needed. Moreover, multiple hardware configurations may be connected via a network. In that case, the multiple hardware configurations may be implemented, for example by a computer (e.g., cloud server) or by an embedded device, such as a camera, a video camera, a personal digital assistant (PDA), or other suitable electronic devices.

Next, various aspects of the present disclosure are described.

### First Exemplary Embodiment

An object of portrait image matting is to predict a degree of transparency of a portrait region (foreground), i.e., determining a possibility that an alpha value of the foreground is 1, an alpha value of the background is 0, and an unknown region having alpha values between 1 and 0 represent a portrait. In the matting task of an exemplary embodiment of the present disclosure, the matting task may be simplified as a segmentation issue; specifically, it is divided typically into a three-category segmentation tasks. The prior art utilizes two types of decoders respectively for segmentation and matting. An object of the present disclosure is to design a decoder capable of restoring rich features of the matting task and the segmentation task at the same time, thereby obtaining a better matting result.

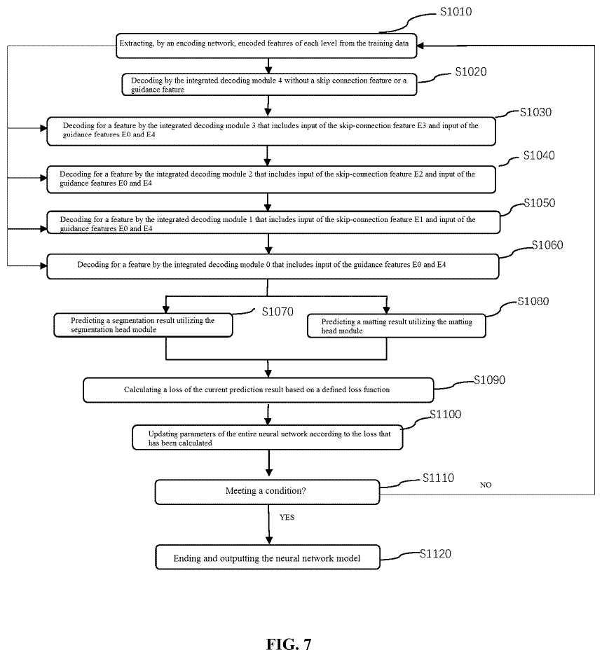

The process during the training of the neural network model according to an exemplary embodiment of the present disclosure is described with reference to FIG. 7. In the exemplary embodiment, the integrated decoder consists of 5 integrated decoding modules with different guidance feature inputs and two head modules for segmentation and matting respectively. Detailed descriptions are as follows.

Step S1010: extracting, by an encoding network, encoded features of each level from the training data.

In this step, the input is a portion of training data selected randomly from the matting database; the encoding network may choose an existing multi-layer neural network, such as ResNet, Transformer, MLP, and the like. After the input of the training data, the encoding network generates five layers of encoded features with gradually decreasing resolutions, respectively named as E0, E1, E2, E3, and E4.

In the context of the present disclosure, “training data” may refer to data including any image, such as a color image, a grayscale image, and the like. The type and format of the image samples are not limited specifically. In addition, the image may be a raw image or a processed version thereof, such as a version of the image that has been subjected to a preliminary filtering or preprocessing before the operation of the present disclosure is performed on the image.

Step S1020: decoding for a feature by the integrated decoding module 4 that does not have a skip connection or a guidance feature.

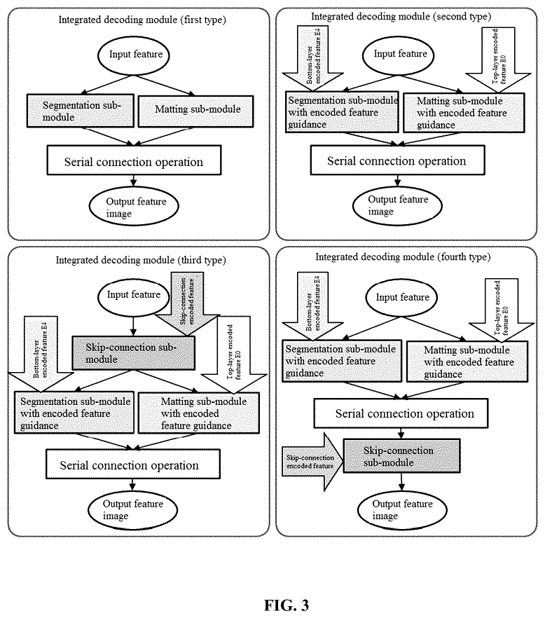

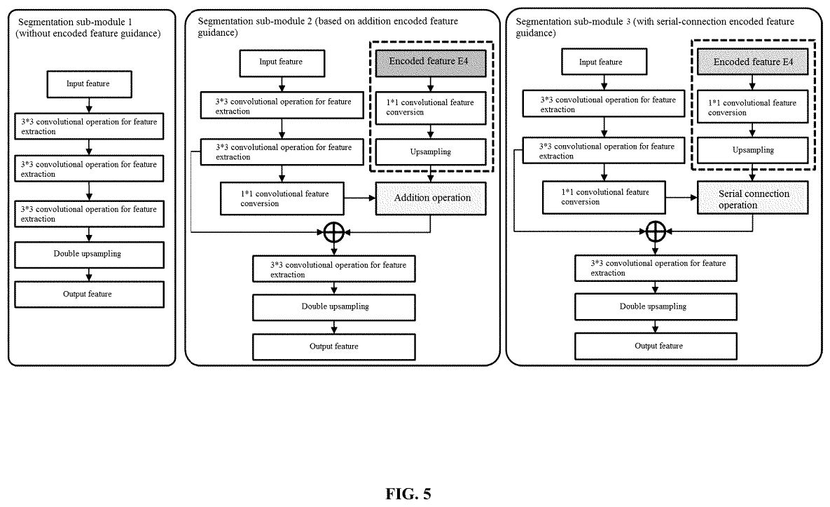

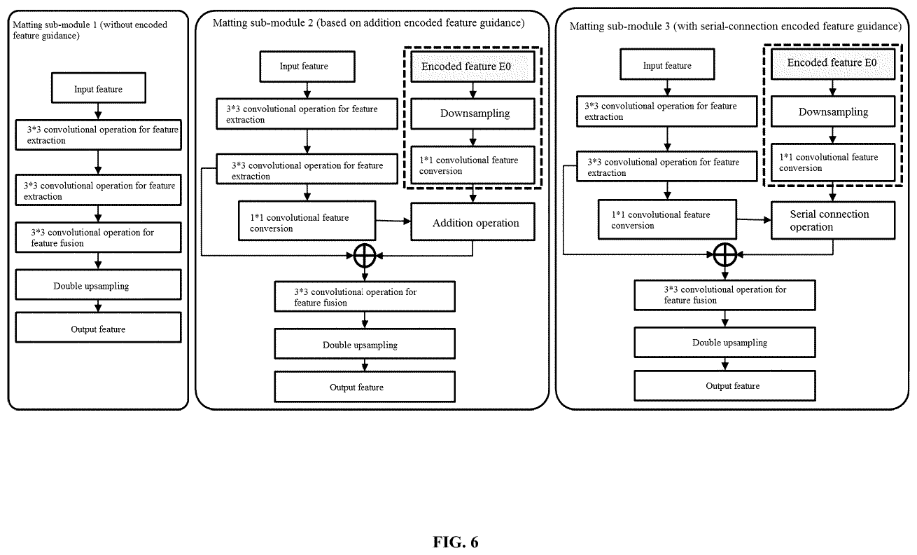

In this step, as shown in FIG. 3, the integrated decoding module 4 is a first type of decoding module that is the simplest and does not include a skip-connection sub-module. The segmentation sub-module is designed to consist of at least two convolutional operations and one upsampling operation in series, such as the first design illustrated in FIG. 5; the matting sub-module takes the same structure, such as the first design illustrated in FIG. 6. After the input of the final encoded feature E4 obtained from the encoding network, the segmentation sub-module and the matting sub-module respectively decode the final encoded feature E4 for features required for their respective tasks, and finally the two decoded features are fused in a serial connection manner as the final decoded feature D4 of the decoding module.

Step S1030: decoding for a feature by the integrated decoding module 3 that includes input of the skip-connection feature E3 and input of the guidance features E0 and E4

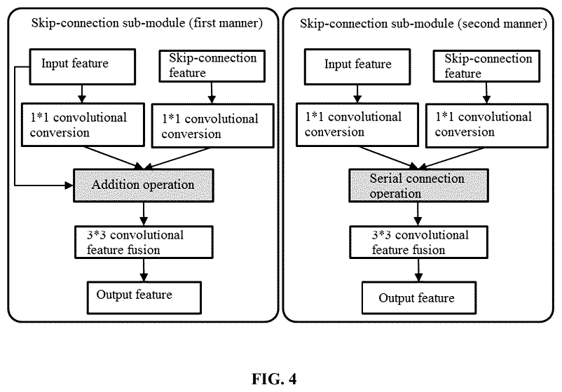

In this step, the integrated decoding module 3 is designed to be a third type of decoding module that is the most complicated, as shown in FIG. 3. The skip-connection sub-module is designed specifically in the first manner as shown in FIG. 4, the segmentation sub-module is designed specifically in the second manner as shown in FIG. 5, and the matting sub-module is designed specifically in the second manner as shown in FIG. 6. First, the skip-connection sub-module performs feature conversion and fusion on the input decoded feature D4 and the skip-connection feature E3, to obtain an enhanced feature. Then, in the segmentation sub-module, first the enhanced feature is partially decoded, then a guidance feature from the encoded feature E4 with high-level semantic information is added, and further decoding and upsampling are performed subsequently, to obtain the decoded feature of the segmentation task; meanwhile in the matting sub-module, first the enhanced feature is partially decoded, then a guidance feature from the encoded feature E0 with low-level texture information is added, and further decoding and upsampling are performed subsequently, to obtain the decoded feature of the matting task. Finally, the two decoded features are fused in a serial connection manner as a final decoded feature D3 of the decoding module.

Step S1040: decoding for a feature by the integrated decoding module 2 that includes input of the skip-connection feature E2 and input of the guidance features E0 and E4

In this step, the integrated decoding module 2 is designed as a third type of decoding module that is the most complicated, as shown in FIG. 3. The skip-connection sub-module is designed specifically in the first manner as shown in FIG. 4, the segmentation sub-module is designed specifically in the second manner as shown in FIG. 5, and the matting sub-module is designed specifically in the second manner as shown in FIG. 6. First, the skip-connection sub-module performs feature conversion and fusion on the input decoded feature D3 and the skip-connection feature E2 to obtain an enhanced feature. Then, in the segmentation sub-module, first the enhanced feature is partially decoded, and then a guidance feature from the encoded feature E4 with high-level semantic information is added, and further decoding and upsampling are performed subsequently, to obtain the decoded feature of the segmentation task; meanwhile in the matting sub-module, first the enhanced feature is partially decoded, then a guidance feature from the encoded feature E0 with low-level texture information is added, and further decoding and upsampling are performed subsequently, to obtain the decoded feature of the matting task. Finally, the two decoded features are fused in a serial connection manner as a final decoded feature D2 of the decoding module.

Step S1050: decoding for a feature by the integrated decoding module 1 that includes input of the skip-connection feature E1 and input of the guidance features E0 and E4

In this step, the integrated decoding module 1 is designed as the third type of decoding module that is the most complicated, as shown in FIG. 3. The skip-connection sub-module is designed specifically in the first manner as shown in FIG. 4, the segmentation sub-module is designed specifically in the second manner as shown in FIG. 5, and the matting sub-module is designed specifically in the second manner as shown in FIG. 6. First the skip-connection sub-module performs feature conversion and fusion on the input decoded feature D2 and the skip-connection feature E1 to obtain an enhanced feature. Then, in the segmentation sub-module, first the enhanced feature is partially decoded, then a guidance feature from the encoded feature E4 with high-level semantic information is added, and further decoding and upsampling are performed subsequently, to obtain the decoded feature of the segmentation task; meanwhile, in the matting sub-module, first the enhanced feature is partially decoded, then a guidance feature from the encoded feature E0 with low-level texture information is added, and further decoding and upsampling are performed subsequently, to obtain the decoded feature of the matting task. Finally, the two decoded features are fused in a serial connection manner as a final decoded feature D1 of the decoding module.

Step S1060: decoding for a feature by the integrated decoding module 0 that includes input of the guidance features E0 and E4.

In this step, the integrated decoding module 0 is designed as the second type of decoding module without the skip-connection sub-module, as shown in FIG. 3. The segmentation sub-module is designed specifically in the second manner as shown in FIG. 5, the matting sub-module is designed specifically in the second manner as shown in FIG. 6. First, the input feature is the decoded feature D1. Then, in the segmentation sub-module, first the input feature is partially decoded, and then a guidance feature from the encoded feature E4 with high-level semantic information is added, and further decoding and upsampling are performed subsequently, to obtain the decoded feature of the segmentation task; meanwhile, in the matting sub-module, first the input feature is partially decoded, a guidance feature from the encoded feature E0 with low-level texture information is added, and further decoding and upsampling are performed subsequently, to obtain the decoded feature of the matting task. Finally, the two decoded features are fused in a serial connection manner as a final decoded feature D0 of the decoding module.

Step S1070: predicting a segmentation result utilizing the segmentation head module.

In this step, the segmentation task is defined as a three-category classification tasks. The input feature is the decoded feature D0. A probability estimation on each pixel belonging to each category is implemented directly by a segmentation head module consisting of convolutional operations, and output as the prediction result of segmentation, i.e., Pₛ^{f}.

Step S1080: predicting a matting result utilizing the matting head module.

In this step, the matting task is defined as a regression task of alpha. The input feature is the decoded feature D0. The matting head module is a combination of a convolutional operation and an activation function for a dense prediction of the alpha of each pixel, and finally outputs the prediction result of the alpha, i.e., α^{M}. The activation function may be a sigmoid function.

Step S1090: calculating a loss of the current prediction result based on a defined loss function.

In this step, the input is the segmentation prediction result and the matting prediction result; the defined loss function is a weighted sum of all defined segmentation loss functions and matting loss functions. The loss of the current prediction result is calculated based on the defined loss function.

For the segmentation task, the segmentation predication result Pₛ^{f}∈R³×H×W and the real segmentation annotated image G∈R³×H×W are given, and a cross-entropy loss function L_{CE}, as shown in Equation 1, is used to calculate a classification loss between them, i.e.,

$${L}_{CE} = - {\sum }_{c = 1}^{3} {\sum }_{h = 1}^{H} {\sum }_{w = 1}^{W} G ( c , h , w ) log {P}_{S}^{f} ( c , h , w ) ) , \qquad ( 1 )$$

wherein c represents a number of categories to be classified in the segmentation, H is the height of the input image, W is the width of the input image.

For the matting task, the matting prediction result α^{M}∈R¹×H×W and the real alpha matte image α∈R¹×H×W are given. On one hand, an alpha loss function is defined in a whole-image region, with a Laplacian loss function and a composition loss function being combined for calculating the loss of the matting task over the whole image. Meanwhile the alpha loss function and the Laplacian loss function are used in an uncertain image region to calculate the loss of a local region for a further optimization on the details. Specifically defined as:

(1) The alpha loss function L_{α} of the whole-image region is defined, in Equation 2, as a root-mean-square error between the predicted alpha and the real alpha corresponding to all pixels in the region of a whole image:

$${L}_{α} = \frac{{\sum }_{i} \sqrt{{( {α}_{i} - {α}_{i}^{M} )}^{2} + {ε}^{2}}}{w \times h} , \qquad ( 2 )$$

wherein i indicates the pixel index for the whole image, h is the height of the input image, w is the width of the input image, and ε=10⁻⁶ is a very small value to ensure the stability of loss calculation.

(2) The Laplacian loss function Lₗₐₚ of the whole-image region is defined, in Equation3, as a distance L1 on a plurality of Laplacian pyramid images between the predicted alpha and the real alpha corresponding to all pixels in the region of a whole image:

$${L}_{lap}^{M} = {\sum }_{i} {W}_{i}^{T} {\sum }_{i = 1}^{5} {‖ {Lap}^{k} ( {α}_{i} ) - {Lap}^{k} ( {α}_{i}^{M} ) ‖}_{1} , \qquad ( 3 )$$

wherein i indicates the pixel index for the whole image, Lap^{k} indicates the Laplacian pyramid image of the k-th layer.

(3) The composition loss function L_{comp} of the whole-image region is defined, in Equation 4, as a root-mean-square error of all pixels in the region of a whole image between a real RGB image c_{g}ⁱ and a RGB image cₚⁱ generated from the predicted alpha, the foreground image and the background image:

$${L}_{comp} = \frac{{\sum }_{i} \sqrt{{( {c}_{p}^{i} - {c}_{g}^{i} )}^{2} + {ε}^{2}}}{w \times h} , \qquad ( 4 )$$

wherein i indicates the pixel index for the whole image, h is the height of the input image, w is the width of the input image, and ε=10⁻⁶ is a very small value to ensure the stability of loss calculation.

(4) The alpha loss function L_{?}^{M} of an uncertain region is defined, in Equation 5, as a root-mean-square error between the predicted alpha and the real alpha corresponding to all pixels in the uncertain region:

$${L}_{α}^{M} = \frac{{\sum }_{i} \sqrt{{( ( {α}_{i} - {α}_{i}^{M} ) \times {W}_{i}^{T} )}^{2} + {ε}^{2}}}{{\sum }_{i} {W}_{i}^{T}} , \qquad ( 5 )$$

wherein i indicates the pixel index for the entire image, Wᵢ^{T}∈{0,1} indicates whether or not a current pixel belongs to the uncertain region, and ε=10⁻⁶ is a very small value to ensure the stability of loss calculation.

(5) The Laplacian loss function Lₗₐₚ^{M} of an uncertain region is defined, in Equation 6, as a distance L1 on a plurality of Laplacian pyramid images between the predicted alpha and the real alpha corresponding to all pixels in the uncertain region:

$${L}_{lap}^{M} = {\sum }_{i} {W}_{i}^{T} {\sum }_{i = 1}^{5} {‖ {Lap}^{k} ( {α}_{i} ) - {Lap}^{k} ( {α}_{i}^{M} ) ‖}_{1} , \qquad ( 6 )$$

wherein i indicates the pixel index for the entire image, Lap^{k} indicates the Laplacian pyramid image of the k-th layer, Wᵢ^{T}∈{0,1} indicates whether or not a current pixel belongs to the uncertain region.

Finally, the final loss function L is defined, in Equation 7, as a weighted sum of all the defined segmentation loss functions and matting loss functions:

$$L = {λ}_{s} {L}_{CE} + {λ}_{m} ( 3 {L}_{α} + 3 {L}_{lap} + {L}_{comp} ) + {λ}_{mu} ( {L}_{α}^{M} + {L}_{lap}^{M} ) , \qquad ( 7 )$$

wherein λₛ=1, λₘ=1, and λₘᵤ=2 are weighting parameters.

Step S1100: updating parameters of the entire neural network according to the calculated loss.

In this step, parameters of the entire neural network are updated with a back propagation algorithm according to the loss calculated in step S1090.

Step S1110: determining whether or not to end the training process.

In this step, it is possible to determine whether or not to end the training process by some preset thresholds, for example whether or not a current loss is less than a given threshold, or whether or not a current number of training iteration cycles has reached a given maximum number of training cycles. In a case that the condition is satisfied, the training of the network model is ended, and the process proceeds to step S1120; otherwise, the process returns to step S1010 to continue with a next training iteration cycle.

The training process on the neural network model is a process of cycles and repetitions. Each training includes three processes of forward propagation, back propagation, and parameter update. The forward propagation process here may be a known forward propagation process. The forward propagation process may include quantization processes for weights of any bits and the feature map, which is not limited here. If a difference value between the actual output result of the neural network model and the expected output result does not exceed a predetermined threshold, it means that the weights in the neural network model are optimal, and that the performance of the trained neural network model has reached the expected performance; thus, the training on the neural network model is completed. Otherwise, if a difference value between the actual output result of the neural network model and the expected output result exceeds the predetermined threshold, it would be necessary to continue with the back propagation process; that is, calculations are performed layer by layer from the top to the bottom in the neural network model based on the difference value between the actual output result and the expected output result, and parameters in the model are updated such that the performance of the network model with the weights updated gets closer to the expected performance.

The neural network model applicable to the present disclosure may be any model that is known in the art, such as a convolutional neural network model, a recurrent neural network model, a graph neural network model, and the like. The present disclosure does not limit the type of the network model.

The computational accuracy of the neural network model applicable to the present disclosure may be any accuracy, either high accuracy or low accuracy. The term “high accuracy” and the term “low accuracy” refer to relative high or low accuracy and do not set limit to specific numerical values. For example, a high accuracy may be of the 32-bit floating-point type; and the low accuracy may be of the 1-bit fixed-point type. Of course, other types of accuracy such as 16-bit, 8-bit, 4-bit, 2-bit and the like are also included in the scope of computational accuracy suitable for the solution of the present disclosure. The term “computational accuracy” may refer to the accuracy of the weights in the neural network model and the accuracy of the inputs to be trained with, which are not limited in the present disclosure. The neural network model described in the present disclosure may be binary neural network models (BNNs) and is of course not restricted from neural network models of other computational accuracies.

Step S1012: outputting the trained convolutional neural network model.

In this step, the current parameters of all layers in the convolutional neural network structure are taken as the trained network model, and the network model and the corresponding parameter information are output.

According to the technical solution of an exemplary embodiment of the present disclosure, portrait segmentation is taken as a simplification of portrait matting. The integrated decoding network is designed to decode for the corresponding information for segmentation and matting at the same time, so that more refined portrait segmentation result and portrait matting result can be obtained at the same time.

### <Exemplary Variant 1>

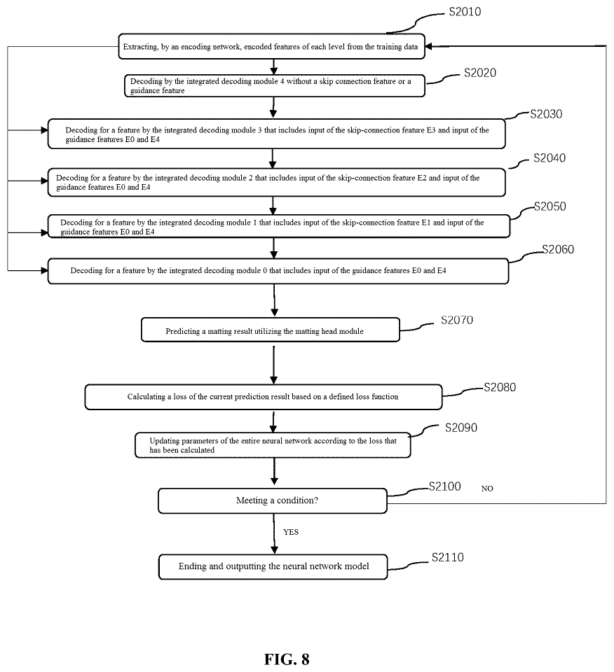

The exemplary embodiment is described below with reference to FIG. 8. The integrated decoder 2 involved in this exemplary embodiment consists of 5 integrated decoding modules with different guidance feature inputs and one matting head module. Compared with the previous embodiment, in this exemplary embodiment the designed integrated decoding network comprises only one head module for regression of portrait alpha, simplifying the model training and the prediction progress. The distinction of this exemplary embodiment lies in comprising a step S2080.

Step S2080: calculating a loss of the current prediction result based on a defined loss function.

In this step, the input is the matting prediction result. The defined loss function is a weighted sum of all defined matting loss functions. The loss of the current prediction result is calculated based on the defined loss function.

For the matting task, the matting prediction result α^{M}∈R¹×H×W and the real alpha image α∈R¹×H×W are given. On one hand, the alpha loss function is defined in the whole-image region, with a Laplacian loss function and a composition loss function being combined for calculating a loss of the matting task over the whole image. Meanwhile, the alpha loss function and the Laplacian loss function are used in the uncertain image region to calculate the loss of the local region for a further optimization on the details. Its specific definitions are the same as those in S1090, referring to the description of S1090. The final loss function L as defined, in Equation 8, is the weighted sum of all defined matting loss functions:

$$L = {λ}_{m} ( 3 {L}_{α} + 3 {L}_{lap} + {L}_{comp} ) + {λ}_{mu} ( {L}_{α}^{M} + {L}_{lap}^{M} ) , \qquad ( 8 )$$

wherein λₘ=1 and λₘᵤ=2 are weighting parameters.

By the method according to this exemplary embodiment, it is possible to simplify the model training and the prediction process. The remaining steps are similar to S2010-2070, S2090-2110 and the steps of the First Exemplary Embodiment, which will not be redundantly described herein.

### <Exemplary Variant 2>

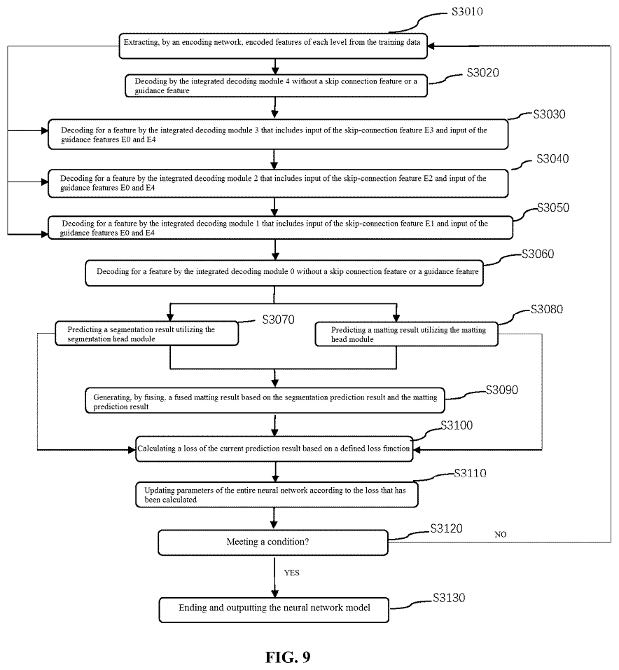

The integrated decoder involved in this exemplary embodiment consists of 5 integrated decoding modules with different guidance feature inputs and three head modules for segmentation, matting, and result fusion respectively. As shown in FIG. 9, the specific description is given below.

Step S3010: extracting, by the encoding network, encoded features of each layer from the training data. The training data may be from a matting training database. This step may employ a method similar to that in step S1010.

Step S3020: decoding for a feature by the integrated decoding module 4 that does not have a skip-connection feature or a guidance feature. This step may employ a method similar to that in step S1020.

Step S5030: decoding for a feature by the integrated decoding module 3 that includes input of the skip-connection feature E3 and input of the guidance features E0 and E4.

In this step, the integrated decoding module 3 is designed as the third type of decoding module that is the most complicated, as shown in FIG. 3. The skip-connection sub-module is designed specifically as a serial-connection-based skip-connection sub-module, as the second manner shown in FIG. 4; the segmentation sub-module is designed specifically as a segmentation sub-module guided by serial-connection-based encoded features, as the third manner shown in FIG. 5; and the matting sub-module is designed specifically as a matting sub-module guided by serial-connection-based encoded features, as the third manner shown in FIG. 6. First, the skip-connection sub-module performs feature conversion and serial connection on the input decoded feature D4 and skip-connection feature E3, to obtain an enhanced feature. Then, in the segmentation sub-module, first the enhanced feature is partially decoded and then serial connected with the guidance feature from the encoded feature E4 with high-level semantic information, and further decoding and upsampling are performed subsequently, to obtain the decoded feature of the segmentation task; meanwhile, in the matting sub-module, first the enhanced feature is partially decoded and then serial connected with the guidance feature from the encoded feature E0 with low-level texture information; further decoding and upsampling are performed subsequently, to obtain the decoded feature of the matting task. Finally, the two decoded features are fused in a serial connection manner as a final decoded feature D3 of the decoding module.

Step S3040: decoding for a feature by the integrated decoding module 2 that includes input of the skip-connection feature E2 and input of the guidance features E0 and E4. The specific processing in this step is similar to that in step S3030.

Step S3050: decoding for a feature by the integrated decoding module 1 that includes input of the skip-connection feature E1 and input of the guidance features E0 and E4. The specific processing in this step is similar to that in step S3030.

Step S3060: decoding for a feature by the integrated decoding module 0 that does not have a skip-connection feature or a guidance feature. The specific processing in this step is similar to that in step S1020.

Step S3070: predicting a segmentation result with the segmentation head module. This step may employ a method similar to that in step S1070.

Step S3080: predicting a matting result with the matting head module. This step may employ a method similar to that in step S1080.

Step S3090: generating a fused matting result based on the segmentation predication result and the matting prediction result.

In this step, the inputs are the segmentation prediction result and the matting prediction result. Based on the segmentation predication result, the alpha of the region segmented as the foreground is set to 1; the alpha of the region segmented as the background is set to 0; and the alpha of other regions is set to the corresponding matting prediction result, to generate the final fused matting result ?^{F} by fusing the alphas of the above three types of regions.

Step S3100: calculating a loss of the current prediction result based on a defined loss function

In this step, the inputs are the segmentation predication result, the matting prediction result, and the fused matting result of steps S3070-3090, with the defined loss function being a weighted sum of all defined segmentation loss functions and matting loss functions. The loss of the current prediction result is calculated based on the defined loss function. The specific calculation process is described below.

For the segmentation task, the defined loss function is the same as that defined in S1090.

For the matting task, the fused matting result α^{F}∈R¹×H×W and the real alpha image α∈R¹×H×W are given. A combination of the alpha loss function, the Laplacian loss function, and the composition loss function is defined in the whole-image region to calculate the loss of the matting task over the whole image, which is defined as below:

(1) The alpha loss function La of the whole-image region is defined, in Equation 9, as a root-mean-square error between the predicted alpha and the real alpha corresponding to all pixels in the region of a whole image:

$${L}_{α} = \frac{{\sum }_{i} \sqrt{{( {α}_{i} - {α}_{i}^{F} )}^{2} + {ε}^{2}}}{w \times h} , \qquad ( 9 )$$

wherein i indicates the pixel index for the whole image, h is the height of the input image, w is the width of the input image, and ε=10⁻⁶ is a very small value to ensure the stability of loss calculation.

The Laplacian loss function Lₗₐₚ of the whole-image region is defined, in Equation 10, as the distance L1 on a plurality of Laplacian pyramid images between the fused alpha and the real alpha corresponding to all pixels in the region of a whole image:

$${L}_{lap} = {\sum }_{i} {\sum }_{i = 1}^{5} {‖ {Lap}^{k} ( {α}_{i} ) - {Lap}^{k} ( {α}_{i}^{F} ) ‖}_{1} , \qquad ( 10 )$$

wherein i indicates the pixel index for the whole image, Lap^{k} indicates the Laplacian pyramid image of the k-th layer.

(3) The composition loss function L_{comp} of the whole-image region is defined, in Equation 11, as a root-mean-square error of all pixels in the region of a whole image between the real RGB image c_{g}ⁱ and the RGB image cₚⁱ generated from the fused alpha, the foreground image and the background image:

$${L}_{comp} = \frac{{\sum }_{i} \sqrt{{( {c}_{p}^{i} - {c}_{g}^{i} )}^{2} + {ε}^{2}}}{w \times h} , \qquad ( 11 )$$

wherein i indicates the pixel index for the whole image, h is the height of the input image, w is the width of the input image, and ε=10⁻⁶ is a very small value to ensure the stability of loss calculation.

For the matting task, the matting prediction result α^{M}∈R¹×H×W and the real alpha image α∈R¹×H×W are given. The alpha loss function and the Laplacian loss function are used only in the uncertain image region to calculate the loss of the local region for a further optimization on the details, specifically defined as below.

(1) The alpha loss function L_{α}^{M} of the uncertain region is defined, in Equation 12, as a root-mean-square error between the predicted alpha and the real alpha corresponding to all pixels in the uncertain region:

$${L}_{α}^{M} = \frac{{\sum }_{i} \sqrt{{( ( {α}_{i} - {α}_{i}^{M} ) \times {W}_{i}^{T} )}^{2} + {ε}^{2}}}{{\sum }_{i} {W}_{i}^{T}} , \qquad ( 12 )$$

wherein i indicates the pixel index for the whole image, Wᵢ^{T}∈{0,1} indicates whether or not a current pixel belongs to the uncertain region, and ε=10⁻⁶ is a very small value to ensure the stability of loss calculation.

(2) The Laplacian loss function Lₗₐₚ^{M} of the uncertain region is defined, in Equation 13, as the distance L1 on a plurality of Laplacian pyramid images between the predicted alpha and the real alpha corresponding to all pixels in the uncertain region:

$${L}_{lap}^{M} = {\sum }_{i} {W}_{i}^{T} {\sum }_{i = 1}^{5} {‖ {Lap}^{k} ( {α}_{i} ) - {Lap}^{k} ( {α}_{i}^{M} ) ‖}_{1} , \qquad ( 13 )$$

wherein i indicates the pixel index for the whole image, Lap^{k} indicates the Laplacian pyramid image of the k-th layer, Wᵢ^{T}∈{0,1} indicates whether or not a current pixel belongs to the uncertain region.

Finally, the final loss function L is defined as the weighted sum of all defined, in Equation 14, segmentation loss functions and matting loss functions:

$$L = {λ}_{s} {L}_{CE} + {λ}_{f} ( 3 {L}_{α} + 3 {L}_{lap} + {L}_{comp} ) + {λ}_{m} ( {L}_{α}^{M} + {L}_{lap}^{M} ) , \qquad ( 14 )$$

wherein ?ₛ=1, ?_{f}=1, and ?ₘ=2 are weighting parameters.

Step S5110: updating parameters of the entire neural network according to the loss that has been calculated. The specific processing in this step is similar to Step S1100.

Step S3120: determining whether or not to end the training process. The specific processing in this step is similar to that in step S1110.

Step S3130: outputting the trained convolutional neural network model. The specific processing in this step is similar to that in step S1120.

According to this exemplary embodiment, portrait segmentation is taken as a target estimation equally important to portrait matting. The parsing feature of the integrated decoding module 0 is simplified. Since portrait segmentation is a relatively simple task, even if a simplified integrated decoding module 0 is used, it is possible to obtain accurate segmentation results by training. Therefore, the integrated decoding network is designed to decode for corresponding information for segmentation and matting at the same time, and fuse the two to generate a fine result combining segmentation and matting.

### <Exemplary Variant 3>

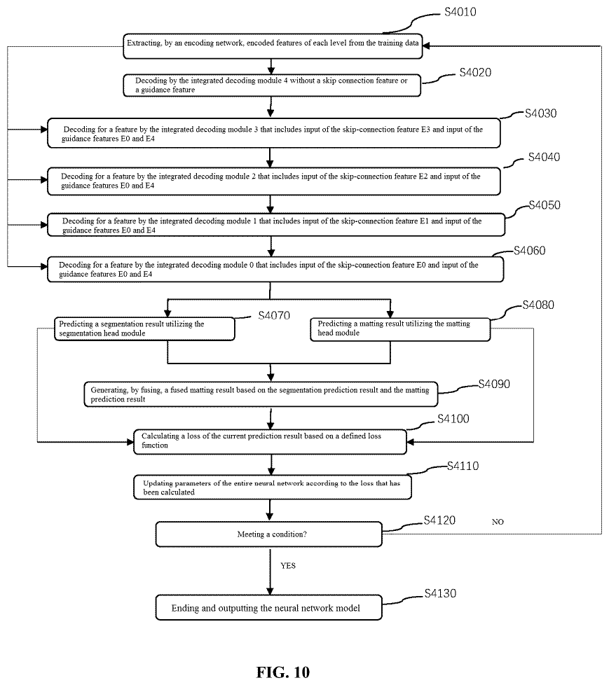

The exemplary embodiment is described below with reference to FIG. 10. The integrated decoder of this exemplary embodiment consists of 5 integrated decoding modules with different guidance feature inputs and three head modules respectively for segmentation, matting, and result fusion, as shown in FIG. 10. The exemplary embodiment is described specifically in the following.

Step S4010: extracting, by the encoding network, encoded features of various layers from the training data. This step may employ a method similar to that in step S1010.

Step S4020: decoding for a feature by the integrated decoding module 4 that does not have a skip connection feature or a guidance feature. This step may employ a method similar to that in step S1020.

Step S4030: decoding for a feature by the integrated decoding module 3 that includes input of the skip-connection feature E3 and input of the guidance features E0 and E4.

In this step, the integrated decoding module 3 is designed as the fourth type of decoding module as shown in FIG. 3. The segmentation sub-module is designed specifically as a segmentation sub-module guided by serial-connection-based encoded features, as the third manner shown in FIG. 5; the matting sub-module is designed specifically as a matting sub-module guided by serial-connection-based encoded features, as the third manner shown in FIG. 6; and the skip-connection sub-module is designed specifically as a serial-connection-based skip-connection sub-module, as the second manner shown in FIG. 4. First, in the segmentation sub-module, the input feature D4 is partially decoded first and then a guidance feature from the encoded feature E4 with high-level semantic information is added, and further decoding and upsampling are performed subsequently, to obtain the decoded feature of the segmentation task; meanwhile, in the matting sub-module, first the input feature D4 is partially decoded, then a guidance feature from the encoded feature E0 with low-level texture information is added, and further decoding and upsampling are performed subsequently, to obtain the decoded feature of the matting task. Next, the two decoded features are fused in a serial connection manner as an intermediate decoded feature of the decoding module 3. Finally, the skip-connection sub-module performs feature conversion and fusion on the input intermediate decoded feature and skip-connection feature E3 to obtain an enhanced decoded feature D3.

Step S4040: decoding for a feature by the integrated decoding module 2 that includes input of the skip-connection feature E2 and input of the guidance features E0 and E4. The specific processing in this step is similar to that in step S4030.

Step S4050: decoding for a feature by the integrated decoding module 1 that includes input of the skip-connection feature E1 and input of the guidance features E0 and E4. The specific processing in this step is similar to that in step S4030.

Step S4060: decoding for a feature by the integrated decoding module 0 that includes input of the skip-connection feature E0 and input of the guidance features E0 and E4. The specific processing in this step is similar to that in step S4030.

Step S4070: predicting a segmentation result by utilizing the segmentation head module. The specific processing in this step is similar to that in step S1070.

Step S4080: predicting a matting result by the matting head module. The specific processing in this step is similar to that in step S1080.

Step S4090: generating, by fusing, a fused matting result based on the segmentation prediction result and the matting prediction result. The specific processing in this step is similar to that in step S3090.

Step S4100: calculating a loss of the current prediction result based on a defined loss function. The specific processing in this step is similar to that in step S3100.

Step S4110: updating parameters of the entire neural network according to the loss that has been calculated. The specific processing in this step is similar to that in step S1010.

Step S4120: determining whether or not to end the training process. The specific processing in this step is similar to that in step S1110.

Step S4130: outputting the trained convolutional neural network model. The specific processing in this step is similar to that in step S1120.

According to this exemplary embodiment, portrait segmentation is taken as a target estimation equally important to portrait matting. The parsing feature of the complicated integrated decoding module 0 is used such that more low-level texture information can be obtained in the matting to decode for a finer feature. Therefore, the integrated decoding network is designed to decode for corresponding information for segmentation and matting at the same time, and fuse the two to generate by fusing a fine result taking both segmentation and matting into account.

### <Exemplary Variant 4>

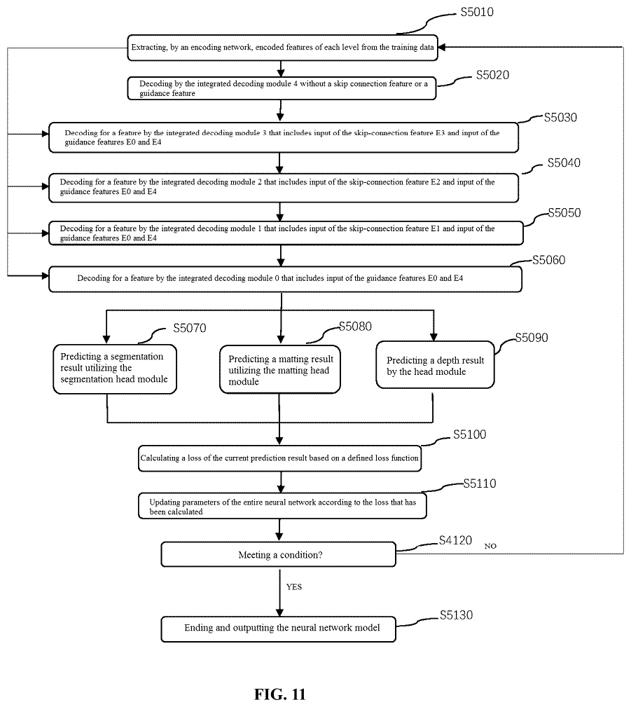

The exemplary embodiment is described subsequently with reference to FIG. 11. The integrated decoder of this exemplary embodiment consists of 5 integrated decoding modules with different guidance feature inputs and three head modules respectively for segmentation, matting, and depth estimation.

Step S5010: extracting, by the encoding network, encoded features of various layers from the training data.

In this step, the input is a portion of training data selected randomly from the matting database. The encoding network may choose an existing multi-layer neural network, such as ResNet, Transformer, MLP, and the like. After the input of training data, the encoding network generates five layers of encoded features with gradually decreasing resolutions, respectively named as E0, E1, E2, E3, and E4.

Step S5020: decoding for a feature by the integrated decoding module 4 that does not have a skip connection feature or a guidance feature.

In this step, the integrated decoding module 4 is designed in a similar way to the first decoding module that is the simplest, as shown in FIG. 3, which does not comprise a skip-connection sub-module. Instead, the segmentation sub-module, the matting sub-module, and the depth sub-module complete the feature decoding for their respective tasks in parallel. The decoded features are connected in series into the final decoded feature. The segmentation sub-module is designed to consist of at least two convolutional operations and one upsampling operation in serial connection, as the first design shown in FIG. 5; the matting sub-module utilizes the same structure, as the first design shown in FIG. 6; the depth sub-module utilizes the same structure, as the first design shown in FIG. 6. After the input of the final encoded feature E4 obtained from the encoding network, the segmentation sub-module, the matting sub-module, and the depth sub-module respectively decode therefrom for the features required for their respective tasks. Finally, the three decoded features are fused in a serial connection manner as the final decoded feature D4.

Step S5030: decoding for a feature by the integrated decoding module 3 that includes input of the skip-connection feature E3 and input of the guidance features E0 and E4.

In this step, the integrated decoding module 3 is designed in a similar way to the third type of decoding module that is the most complicated, as shown in FIG. 3. The skip-connection sub-module is designed specifically in the first manner as shown in FIG. 4; the segmentation sub-module is designed specifically in the second manner as shown in FIG. 5; the matting sub-module is designed specifically in the second manner as shown in FIG. 6; the depth sub-module and the matting sub-module are the same, designed specifically in the second manner as shown in FIG. 6. First, the skip-connection sub-module performs feature conversion and fusion on the input decoded feature D4 and skip-connection feature E3 to obtain an enhanced feature. Then, in the segmentation sub-module, first the enhanced feature is partially decoded, and then a guidance feature from the encoded feature E4 with high-level semantic information is added, and further decoding and upsampling are performed subsequently, to obtain the decoded feature of the segmentation task; meanwhile, in the matting sub-module, first the enhanced feature is partially decoded, then a guidance feature from the encoded feature E0 with low-level texture information is added, and further decoding and upsampling are performed subsequently, to obtain the decoded feature of the matting task;

meanwhile, in the depth sub-module, first the enhanced feature is partially decoded, then a guidance feature from the encoded feature E0 with low-level texture information is added, and further decoding and upsampling are performed subsequently, to obtain the decoded feature of the depth task. Finally, the three decoded features are fused in a serial connection manner as the final decoded feature D3 of the decoding module.

Step S5040: decoding for a feature by the integrated decoding module 2 that includes input of the skip-connection feature E2 and input of the guidance features E0 and E4. The specific processing in this step is similar to that in step S5030.

Step S5050: decoding for a feature by the integrated decoding module 1 that includes input of the skip-connection feature E1 and input of the guidance features E0 and E4. The specific processing in this step is similar to that in step S5030.

Step S5060: decoding for a feature by the integrated decoding module 0 that includes input of the guidance features E0 and E4.

In this step, the integrated decoding module 0 is designed in a similar way to the second type of decoding module that does not have a skip-connection sub-module, as shown in FIG. 3. The segmentation sub-module is designed specifically in the second manner as shown in FIG. 5; the matting sub-module is designed specifically in the second manner as shown in FIG. 6; the depth sub-module is the same with the matting sub-module, designed specifically in the second manner as shown in FIG. 6. First, the input feature is the decoded feature D1. Then, in the segmentation sub-module, first the input feature is partially decoded, and then a guidance feature from the encoded feature E4 with high-level semantic information is added, and further decoding and upsampling are performed subsequently, to obtain the decoded feature of the segmentation task; meanwhile, in the matting sub-module, first the input feature is partially decoded, then a guidance feature from the encoded feature E0 with low-level texture information is added, and further decoding and upsampling are performed subsequently, to obtain the decoded feature of the matting task; meanwhile, in the depth sub-module, first input feature is partially decoded, a guidance feature from the encoded feature E0 with low-level texture information is added, and further decoding and upsampling are performed subsequently, to obtain the decoded feature of the depth task. Finally, the three decoded features are fused in a serial connection manner as the final decoded feature D0 of the decoding module.

Step S5070: predicting a segmentation result by the segmentation head module. The specific processing in this step is similar to that in step S1070.

Step S5080: predicting a matting result by the matting head module. The specific processing in this step is similar to that in step S1080.

Step S5090: predicting a depth result by the head module. The specific processing in this step is similar to that in step S1080.

Step S5100: calculating a loss of the current prediction result based on a defined loss function.

In this step, the input is the segmentation prediction result and the matting prediction result; the defined loss function is the weighted sum of all defined segmentation loss functions, matting loss functions, and depth loss functions. The loss of the current prediction result is calculated based on the defined loss functions. The segmentation loss function and the matting loss function are defined the same as in that in step S1090.

For the depth estimation task, the depth prediction result d^{P}∈R¹×H×W and the real depth image d∈R¹×H×W are given. The alpha loss function and the Laplacian loss function are used in the region of whole image to calculate the loss of the depth estimation.

Finally, the final loss function L is defined, in Equation 15, as the weighted sum of all defined segmentation loss functions, matting loss functions and depth loss functions:

$$L = {λ}_{s} {L}_{CE} + {λ}_{m} ( 3 {L}_{α} + 3 {L}_{lap} + {L}_{comp} ) + {λ}_{mu} ( {L}_{α}^{M} + {L}_{lap}^{M} ) , \qquad ( 15 )$$

wherein λₛ=1, λₘ=1, and λₘᵤ=2 are weighting parameters.

Step S5110: updating parameters of the entire neural network according to the loss that has been calculated. The specific processing in this step is similar to that in step S1100.

Step S5120: determining whether or not to end the training process. The specific processing in this step is similar to that in step S1110.

Step S5130: outputting the trained convolutional neural network model. The specific processing in this step is similar to that in step S1120.

According to this exemplary embodiment, depth estimation is also taken as a task objective. The integrated decoding network is designed to decode for corresponding information for segmentation, matting, and depth at the same time and eventually obtain a portrait segmentation result, a portrait matting result, and a depth estimation result.

By the method according to the exemplary embodiment of the present disclosure, the encoding-integrated decoding network based on a U-Net architecture is capable of parsing, from encoded features, rich features expressing segmentation and matting at the same time, thereby improving the accuracy of portrait matting.

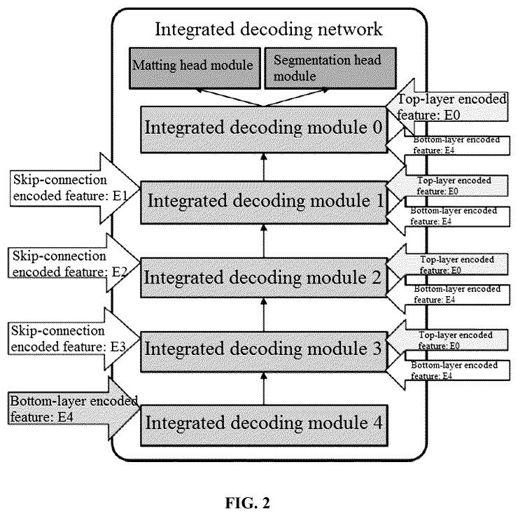

Specifically, as shown in FIG. 2, the integrated decoding network according to the exemplary embodiment of the present disclosure consists of a plurality of cascaded integrated decoder modules, each decoding module parsing for an integrated feature based on different features from the encoder. The final integrated features may be used for the segmentation task and the matting task, respectively.

In the integrated decoding network according to the exemplary embodiment of the present disclosure, as shown in FIG. 3, different integrated decoding modules are designed for different input encoded features. Specifically, the input feature may be optionally be enhanced by the skip-connection sub-module and a specific feature from the encoder. Then feature conversion is performed on the enhanced feature image by the segmentation sub-module and the matting sub-module to restore the respective different features, which are integrated into the final output feature. Optionally, the segmentation sub-module and the matting sub-module use different encoded features to guide the feature conversion. In the integrated decoding network according to the exemplary embodiment of the present disclosure, the integrated decoding module 4 employs the first design as shown in FIG. 3, the integrated decoding module 0 employs the second design, the integrated decoding module 1, the integrated decoding module 2, and the integrated decoding module 3 employ the third design.

Among the integrated decoding modules according to the exemplary embodiment of the present disclosure, for different task objectives, in order to effectively decode for features required for the respective task objectives, there are further designed the skip-connection sub-module, the segmentation sub-module, and the matting sub-module. As shown in FIG. 4, optionally the skip-connection sub-module utilizes a specific encoded feature skip-connected from the encoder and the current input feature for feature conversion and fusion to obtain an enhanced input feature. In the segmentation sub-module, optionally the encoded feature E4 is from the output of a lowermost layer of the encoder and represents the high-level semantic information acquirable by the encoder, and is capable of providing important information for the segmentation task. Therefore, the segmentation sub-module decodes the input feature partially, and then adds the guidance feature from the encoded feature E4, and subsequently performs further decoding and upsampling, to obtain the final decoded feature, as shown in FIG. 5. In the matting sub-module, optionally the encoded feature E0 is from the output of the topmost layer of the encoder and represents the low-level texture information acquirable by the encoder, and is capable of providing important detail information for the matting task. Accordingly, the matting sub-module decodes the input feature partially, then adds the guidance feature from the encoded feature E0, and subsequently performs further decoding and upsampling, to obtain the final output feature, as shown in FIG. 6.

In addition, for the two different tasks of segmentation and matting, prediction results of the respective tasks need to be obtained from the decoded features. For this purpose, the segmentation head module and the matting head module are designed respectively. Since the segmentation task is actually a three-category classification task, the segmentation head module is formed directly from convolutional operations to realize a probability estimation on each pixel belonging to each category. Further, since the matting task is in fact a regression issue, the matting head module is designed to complete a dense prediction of the alpha of each pixel by a combination of convolutional operations and activation functions.

Furthermore, for the segmentation task, a common cross-entropy loss function is used to calculate the classification loss. For the matting task, a combination of the common alpha loss function, the Laplacian loss function, and the composition loss function is used in the whole-image region to calculate the loss of the whole image. Meanwhile, the alpha loss function and the Laplacian loss function are used in the uncertain region to a further optimization on the details.

The integrated decoding module according to the exemplary embodiment is divided into two branch modules, i.e., segmentation and matting, to decode for different feature representations. The two are subsequently combined into an integrated feature for a mutually impaction on each other. The integrated decoding module according to the exemplary embodiment may choose to enhance an intermediate integrated decoded feature by a skip-connection feature from the encoding module, thereby facilitating the information recovery for segmentation and matting at the same time. The segmentation decoding modules and matting decoding modules according to the exemplary embodiment may employ a smaller number of channels to recovery information, without affecting the accuracy.

Subsequently the performance of the present disclosure and the performance of the prior art are compared through an experiment.

Experiment: verification on the P3M-10k training set.

Training set: P3M-10k (9421 images) and 906 available images selected from other datasets.

Test set: RealWorldPortrait_636, P3M_500_NP, P3M_500_P.

Evaluation criteria: MSE (10-3, whole-image), SAD (whole-image), MSE (10-3, uncertain region), SAD (uncertain region), model size (MB), MACs (G), average MACs (K).

Architecture of convolutional neural network: RestNet34-mp.

Comparison with prior art: prior art (P3M-Net).

### Experimental Result:

Table 1 shows a comparison of the accuracy of the present disclosure and that of the prior art on a general-purpose dataset.

TABLE 1

| | | MSE (10-3, | SAD | MSE (10-3, | SAD |
|---|---|---|---|---|---|
| | | whole- | (whole- | uncertain | (uncertain |
| Dataset | Algorithm | image) | image) | region) | region) |
| RealWorldPortrait_636 | Prior art | 17.251 | 8.035 | 72.547 | 5.792 |
| | the present | 16.025 | 7.748 | 69.499 | 5.684 |
| | disclosure | | | | |
| P3M_500_NP | prior art | 3.453 | 1.898 | 17.247 | 1.319 |
| | the present | 2.983 | 1.804 | 15.396 | 1.293 |
| | disclosure | | | | |
| P3M_500_P | prior art | 3.325 | 1.781 | 20.034 | 1.294 |
| | the present | 2.836 | 1.647 | 18.893 | 1.254 |
| | disclosure | | | | |

Table 2 shows a comparison between the model scales from training of the present disclosure and that of the prior art.

TABLE 2

| | Comparison of models from training | | |
|---|---|---|---|
| | Model size | MACs | Average MACs |
| Algorithm | (MB) | (G) | (K) |
| prior art | 155.86 | 58.998 | 225.06 |
| the present | 113.076 | 43.524 | 166.031 |
| disclosure | | | |

The experimental results demonstrate that: compared to the prior art and according to the exemplary embodiment of the present disclosure, portrait segmentation is simplified as portrait matting, integrated decoding modules are designed, and corresponding information for segmentation and matting are decoded out at the same time, and finer portrait matting results can be finally obtained.

### Second Exemplary Embodiment

Based on the afore-described first exemplary embodiment, the second exemplary embodiment of the present disclosure describes a network model training system, comprising a terminal, a communication network, and a server. The terminal and the server perform communication via the communication network. The server trains a network model stored in the terminal online with a network model stored locally, such that the terminal is capable of carrying out real-time businesses using the trained network model. Various parts of the training system according to the second exemplary embodiment of the present disclosure are described below.

The terminal in the training system may be an embedded image collection device such as a security camera, and may alternatively be a device such as a smartphone, a PAD, etc. Of course, the terminal may not be a terminal such as an embedded device of relatively low computational capabilities, but is other terminals of relatively high computational capabilities. The number of the terminals in the training system may be determined according to the actual needs. For instance, if the training system is for training security cameras in a shopping mall, all security cameras in the shopping mall may be deemed as terminals. In that case, the number of the terminals in the training system is fixed. For another instance, if the training system is for training smartphones of users in the shopping mall, all smartphones accessed to the wireless local network of the shopping mall may be deemed as terminals. In that case, the number of the terminals in the training system is not fixed. The second exemplary embodiment of the present disclosure does not limit the type and the number of the terminals in the training system as long as the terminal is capable of storing and training a network model.

The server in the training system may be a high-performance server of relatively high computational capabilities, such as a cloud server. The number of the server in the training system may be determined according to the number of terminals to be served. For example, if the number of terminals to be trained in the training system is relatively small or the geographical range in which the terminals are distributed is relatively small, the number of servers in the training system may be smaller; for example, there may be only one server. If the number of terminals to the trained in the training system is relatively great or the geographical range in which the terminals are distributed is relatively large, the number of servers in the training system may be greater; for example, a server cluster is established. The second exemplary embodiment of the present disclosure does not limit the type and the number of the server in the training system as long as the server is capable of storing at least one network model and providing information for training the network model stored in the terminal.

The communication network of the second exemplary embodiment of the present disclosure is wireless network or wired network realizing information transmission between the terminal and the server. All networks currently available in up/downlink transmission between network servers and terminals may be used as the communication network in this embodiment. The second exemplary embodiment of the present disclosure does not limit the type and the communication method of the communication network. Of course, the second exemplary embodiment of the present disclosure is not restricted to any other communication method. For example, a third-party storage region may be assigned to the training system. When information is to be transmitted by either of the terminal and the server to the other, the information to be transmitted is stored in the third-party storage region. The terminal and the server read information in the third-party storage region at regular times to realize information transmission therebetween.

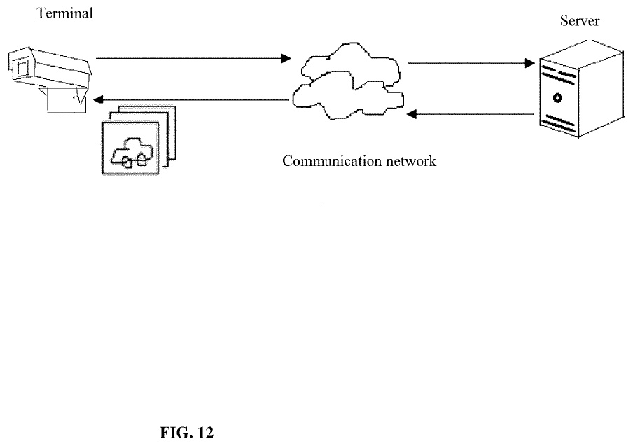

With reference to FIG. 12, the online training process of the training system according to the second exemplary embodiment of the present disclosure is described in details. FIG. 12 illustrates an example of the training system. The training system is assumed to comprise a terminal and a server. The terminal is capable of real-time photographing. It is assumed that the terminal stores a network model which can be trained and can process images, and the server stores the same network model. The training process of the training system is described below.

Step S201: the terminal initiates a training request to the server via the communication network.

The terminal initiates a training request to the server via the communication network. The request includes information such as a terminal identifier and the like. The terminal identifier is information uniquely representing the identity of the terminal (e.g., an ID or IP address of the terminal).

The above step S201 is explained with an example in which one terminal initiates the training request. Of course a plurality of terminals may initiate training requests in parallel. The processes of a plurality of terminals are similar to the process one terminal, and is thus not redundantly described herein.

Step S202: the server receives the training request.

The training system shown in FIG. 12 comprises only one server. Therefore, the communication network may transmit the training request initiated by the terminal to the server. If the training system comprises a plurality of servers, the training request may be transmitted to a relatively idle server in view of the idleness of the servers.

Step S203: the server responds to the received training request.

The server determines the terminal initiating the request according to the terminal identifier included in the received training request, to determine the network model to be trained stored in the terminal. An option is that the server determines the network model to be trained stored in the terminal initiating the request according to a comparison table of the terminals and the network models to be trained. Another option is that the training request includes information of the network model to be trained, and the server may determine the network model to be trained according to the information. Here, determining the network model to be trained includes, but not limited to, determining information characterizing the network model, such as a network architecture, a hyperparameter of the network model, and the like.

When the server determines the network model to be trained, the method of the first exemplary embodiment of the present disclosure may be used to train the network model stored in the terminal initiating the request using the same network model stored locally in the server. Specifically, according to the method of the first exemplary embodiment, the server updates the weights in the network model locally, and transmits the updated weights to the terminal so that the terminal synchronizes the network model to be trained stored in the terminal based on the received updated weights. Here, the network model in the server and the network model to be trained in the terminal may be the same network model; or the network model in the server may be more complicated than the network model in the terminal, but the two have close outputs. The present disclosure does not limit the type of the network model for training in the server and the network model to be trained in the terminal as long as the updated weights output from the server can make the network model in the terminal synchronized, such that the output by the synchronized network model in the terminal becomes closer to the expected output.

In the training system shown in FIG. 12, the terminal initiates the training request actively. Optionally, the second exemplary embodiment of the present disclosure is not limited to broadcasting inquiry information by the server and then responding to the inquiry information by the terminal for the afore-described training process.

By the training system according to the second exemplary embodiment of the present disclosure, the server can train the network model in the terminal online, improving the flexibility of the training while greatly improving the capability of the terminal to handle businesses and expanding business handling scenarios of the terminal. In the second exemplary embodiment the training system is described in the foregoing with online training as an example. But the present disclosure is not limited to offline training process, which is not redundantly described herein.

### Third Exemplary Embodiment

The third exemplary embodiment of the present disclosure describes a training apparatus for a neural network model. The apparatus can execute the training method described in the first exemplary embodiment. Moreover, when applied to an online training system, the apparatus may be an apparatus in the server described in the second exemplary embodiment.

The training apparatus of this embodiment further comprises modules for realizing the functions of the server in the training system, such as the functions of identifying received data, data packaging, network communication, etc., which are not redundantly described herein.

### Further Embodiments

The present disclosure is applicable to various applications. For example, the present disclosure is adapted for monitoring, identifying, and tracking an object in a static image or a moving video captured by a camera, and is particularly advantageous for a portable device equipped with a camera, a (camera-based) mobile phone, and the like.

It is appreciated that the method and the device described herein can be implemented by software, firmware, hardware, or any combination thereof. Some component may be implemented for example as software that runs on a digital signal processor or a microprocessor. Other components may be implemented for example as hardware and/or Application Specific Integrated Circuits.

In addition, the method and the system of the present disclosure may be implemented in various manners. For example, the method and the system of the present disclosure may be implemented by software, firmware, hardware, or any combination thereof. The order of steps of the method as described in the foregoing is merely illustrative. Unless otherwise specified, the order of steps of the method of the present disclosure is not limited to the specific order described in the foregoing. Furthermore, in some embodiments, the present disclosure is embodied as a program recorded in a recording medium, comprising machine-readable instructions for implementing the method according to the present disclosure. Therefore, the present disclosure also covers the recording medium storing the program for implementing the method according to the present disclosure.

A person skilled in the art should be aware that the boundaries between operations described in the foregoing are merely illustrative. Multiple operations may be combined into a single operation; and a single operation may be distributed in additional operations; and operations may be executed at least partially temporally overlapping. In addition, the optional embodiments may include various instances of specific operations, and the sequence of operations may vary in various other embodiments. Additional modifications, variations, and substitutions are also possible. Therefore, the description and the drawings should be considered to be illustrative but not limiting.

Although specific embodiments of the present disclosure have been described above by examples, it will be appreciated by a person skilled in the art that the above examples are merely illustrative and are not intended to limit the scope of the present disclosure. Various embodiments described herein may be combined arbitrarily without departing from the spirit and scope of the present disclosure. It will also be appreciated by a person skilled in the art that various modifications may be made to the embodiments without departing from the spirit and scope of the present disclosure.

What is claimed is:

1. An image processing method, the method comprising:
generating, in an encoding step, a plurality of encoded features of different resolutions based on an input image that is input into an encoder;
decoding, in a decoding step that based on the plurality of encoded features using a decoder of a plurality of cascaded decoding modules, for decoded features of a same resolution as that of the input image; and
predicting an output image of a same resolution as the input image, based on the decoded features and a head module.

2. The method according to claim 1, wherein the output image is an alpha image, a segmentation image, a depth image, or a combination thereof.

3. The method according to claim 1, wherein the encoder is a multi-layer neural network and further comprising generating encoded features of gradually decreasing resolutions, wherein the multi-layer neural network is ResNet, Transformer, or MLP.

4. The method according to claim 1, wherein each of the plurality of decoding modules of the decoder respectively generates a decoded feature of a resolution consistent to an encoded feature generated in a corresponding encoding step.

5. The method according to claim 1, wherein each of the decoding modules has at least one input feature, wherein the at least one input feature is from an output feature of another decoding module or from an output feature of an encoding step, each of the decoding modules comprises at least one upsampling operation and at least one convolutional operation and generates an output feature.

6. The method according to claim 5, the input feature comprises at least one of an output feature of a previous decoding module or an encoded feature output from the encoding step, wherein the input feature further comprises an encoded feature with high-layer semantic, an encoded feature with low-layer detail, and a corresponding encoded feature.

7. The method according to claim 5, wherein, in the decoding step, the decoding module comprises at least one sub-module that performs an upsampling operation and a convolutional operation to decode for features for different targets.

8. The method according to claim 7, wherein one of the at least one sub-module is a segmentation sub-module corresponding to a segmentation task and further comprising performing an operation for guiding a segmentation using the segmentation sub-module comprises.

9. The method according to claim 8, wherein the operation for guiding a segmentation further comprises performing a conversion operation and an upsampling operation, and calculates an intermediate feature for guiding a segmentation from a high-layer semantic encoded feature and adds the intermediate feature for guiding a segmentation to features for the segmentation sub-module by a first operation.

10. The method according to claim 7, wherein one of the at least one sub-modules is a matting sub-module that performs a matting task comprising at least a convolutional operation and an upsampling operation, and further comprising performing an operation for guiding a matting.

11. The method according to claim 10, wherein the operation for guiding the matting further comprises performing a conversion operation and a downsampling operation, and calculates an intermediate feature for guiding the matting from a low-layer detail encoded feature and adds the intermediate feature for guiding the matting to features for the matting sub-module by a first operation.

12. The method according to claim 10, wherein one of the at least one sub-modules is a depth sub-module that performs a depth estimation task, the depth sub-module having a structure same as a structure of the matting sub-module.

13. The method according to claim 5, wherein generating the output feature includes using different decoded features by integrated operations based on addition or serial connection between the integrated operations.

14. The method according to claim 7, wherein in the decoding module a skip-connection sub-module located before the at least one sub-module is included.

15. The method according to claim 7, wherein the decoding module comprises a skip-connection sub-module located after the at least one sub-module.

16. The method according to claim 14, further comprising:
Performing, by the skip connection submodule, a plurality of feature conversion operations that perform conversion on an input feature and a corresponding skip connection encoded feature to obtain a converted feature,
Enhancing, by a first operation the input feature based on the converted feature,
Fusing, by a convolutional operation, an enhanced feature to an output feature.

17. The method according to claim 9, wherein enhancing by the first operation further comprises combining specified features by an addition or a serial connection method.

18. The method according to claim 1, wherein the head module comprises a matting head module, the head module comprises at least one convolutional operation and an activation operation.

19. The method according to claim 1, wherein the head module comprises a segmentation head module that performs at least one convolutional operation and generates a segmentation image from a final encoded feature.

20. The method according to claim 19, wherein the head module comprises a fusion operation, and the fusion operation fuses the segmentation image into the output image to generate a final output image.

21. The method according to claim 16, wherein enhancing by the first operation combines specified features by an addition or a serial connection method.

22. An image processing apparatus, comprising:
at least one memory storing instructions; and
at least one processor that, upon execution of the stored instructions, is configured to operate as:
an encoding unit configured to generate, based on an input image and an encoder, a plurality of encoded features of different resolutions;
a decoding unit configured to decode, based on the plurality of encoded features and a decoder of a plurality of cascaded decoding modules, for decoded features of a same resolution as that of the input image; and
a prediction unit configured to predict, based on the decoded features and a head module, an output image of a same resolution as that of the input image.

23. A non-transitory computer-readable storage medium storing computer program for causing a computer to function as:
an encoding unit configured to generate, based on an input image and an encoder, a plurality of encoded features of different resolutions;
a decoding unit configured to decode, based on the plurality of encoded features and a decoder of a plurality of cascaded decoding modules, for decoded features of a same resolution as that of the input image; and
a prediction unit configured to predict, based on the decoded features and a head module, an output image of a same resolution as that of the input image.
